(19) United States
(12) Patent Application Publication
(10) Pub. No.: US 2004/0118164 A1
(43) Pub. Date: Jun. 24, 2004

(54) Method for heat treating a glass article

(76) Inventors: Heather D. Boek, Corning, NY (US); Carl W. Ponader, Beaver Dams, NY (US)

Correspondence Address: CORNING INCORPORATED, SP-TI-3-1, CORNING, NY, 14831

(21) Appl. No.: 10/328,092

(22) Filed: Dec. 19, 2002

(51) Int. Cl. C03B 37/018

(52) U.S. Cl. 65/398; 65/397; 65/412; 65/413

(57) ABSTRACT

A method of forming an optical fiber by heat treating a consolidated glass article, doped with at least one refractive index-modifying dopant, at a temperature between about 1100° C. and 1400° C. and for a time between about 1 hour and 12 hours in a helium-containing atmosphere. The consolidated glass article is an optical fiber precursor. The optical fiber drawn from the heat treated consolidated glass article exhibits an attenuation lower than an optical fiber drawn from a substantially identical optical fiber precursor that has not been heat treated in accordance with the present invention.

### BACKGROUND OF THE INVENTION

1. Field of the Invention

The present invention relates generally to a method for manufacturing an optical fiber, and more particularly, a method for decreasing the chemical inhomogeneity of a consolidated doped glass article used in the manufacture of optical fiber by heat treating the glass article.

2. Technical Background

Attenuation is a principal limiting attribute of optical fibers. Optical fiber loss, for example, plays an important role in setting the limiting distance between optical fiber amplifiers. This is particularly important in long distance and ultra-long distance networks such as, for example, undersea applications where such amplifiers represent a significant system cost, as well as a major factor in system reliability. Consequently there is a tremendous amount of commercial interest in reducing attenuation to the lowest possible level.

For silica-based optical fibers used in long distance telecommunication transmission networks, attenuation losses have been reduced to the point where most of the remaining attenuation is due to intrinsic scattering within the glass material, including Rayleigh scattering. It is generally accepted that intrinsic scattering is a combination of losses associated with density and dopant concentration fluctuations. Nanometer-scale chemical inhomogeneity in the optical fiber contribute to scattering losses by creating fluctuations in the local refractive index of the fiber. By local refractive index we mean the refractive index on a nanometer scale.

One method for producing a glass article for use in the fabrication of an optical fiber includes synthesizing glass soot by flame hydrolysis, wherein glass forming chemical precursors, such as, for example, SiCl₄ and GeCl₄, are introduced into a burner flame and oxidized. The resulting glass soot may be deposited longitudinally on the periphery of a rotating starting rod to form a porous glass preform. The porous glass preform is then heated to form a consolidated glass preform. By consolidated we mean the glass is made clear and nonporous, being either substantially or completely free of interstitial voids that characterize the space between individual glass particles comprising soot in a porous glass preform.

The foregoing process is generally referred to as outside vapor deposition (OVD, one of a number of processes that comprise the family of chemical vapor deposition processes. Glass soot may also be deposited axially in a process commonly referred to as vapor axial deposition (VAD). As in the OVD process, VAD requires that the porous glass preform be consolidated after the soot deposition step to form a nonporous glass preform. Alternatively, glass soot may be deposited on the inside surface of a rotating glass substrate tube. In this method, commonly referred to as modified chemical vapor deposition (MCVD), the porous glass soot is consolidated during the deposition step. The common feature of these and other chemical vapor deposition processes is that glass soot is first deposited and then consolidated to form a nonporous glass body. Unfortunately, chemical inhomogeneities may be produced during deposition of the glass soot that create fluctuations in the local refractive index of the consolidated glass. In the case of SiO₂—GeO₂ glass systems commonly employed in the manufacture of optical fiber, regions of high GeO₂ concentration may form, where the nanometer-scale variations of the GeO₂ dopant are of the size of individual soot particles. It has been found that fluctuations in dopant concentration that occur during the deposition process, and therefore refractive index fluctuations in the consolidated glass, are not eliminated during the drawing of individual optical fibers. As a result, these refractive index fluctuations can find their way into the drawn optical fiber and produce increased optical attenuation by increasing scattering losses. It would be useful therefore to devise a method for reducing or eliminating nanometer-scale chemical inhomogeneity in glass articles used in the manufacture of optical fiber prior to the fiber drawing process.

### SUMMARY OF THE INVENTION

The present invention is related to a method of making an optical fiber including forming a consolidated glass article by a chemical vapor deposition process, wherein the consolidated glass article is doped with at least one index of refraction-modifying dopant, and heat treating the consolidated glass article at a predetermined temperature in the range from about 1100° C. to 1400° C. for a time between about 1 hour to 12 hours in an atmosphere comprising helium to form an optical fiber precursor.

In one embodiment, the consolidated glass article is a consolidated optical fiber core preform. By core preform we mean a glass article which will be drawn into at least one glass rod, or core cane, and which core cane, when further formed into a complete consolidated optical fiber perform and subsequently heated and drawn into an optical fiber, will form at least a portion of the optical fiber core.

In another embodiment, the consolidated glass article is a glass rod, hereinafter referred to as a core cane. By core cane we mean a consolidated glass article to which additional glass will be further applied to form a complete consolidated optical fiber preform. When the complete consolidated optical fiber preform is subsequently drawn into an optical fiber, the core cane forms at least a portion of the optical fiber core.

In yet another embodiment of the invention, the glass article is a complete consolidated optical fiber preform. By complete consolidated optical fiber preform we mean a fully formed and consolidated glass article which, when heated and drawn to a predetermined diameter, will form a complete optical fiber. A typical predetermined diameter, for example, is 125 microns. Other parameters are possible, depending upon the purpose and design of the optical fiber.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 illustrates the application of a coating of glass soot to a mandrel.

FIG. 2 is a cross-sectional view of a consolidated optical fiber core preform.

FIG. 3 is a schematic diagram illustrating the drawing of a core cane from the consolidated optical fiber core preform.

FIG. 4 illustrates the application of an overclad layer of soot to a core cane.

FIG. 5 is a schematic representation of a consolidation furnace and consolidation atmosphere system.

FIG. 6 shows shows time-temperature data for a diffusion length of 30 nm.

FIG. 7 is a graph showing attenuation at 1550 nm versus draw speed for both treated and untreated optical fibers manufactured at a draw tension of 100 grams.

### DETAILED DESCRIPTION OF THE INVENTION

The invention relates to a method for heat treating a consolidated glass article formed by chemical vapor deposition before the glass article is further processed into an optical fiber.

Without wishing to be bound by theory, it has nonetheless been proposed that nanometer-scale chemical inhomogeneity occurs in optical fiber chemical vapor deposition processes because the hydrolysis rate for the SiO₂ precursor chemical, for example SiCl₄, is different than the hydrolysis rate for dopant materials used to modify the index of refraction of the silica glass. For example, GeCl₄ has a much larger hydrolysis rate than the hydrolysis rate for SiCl₄. In the case of germania-doped silica glass commonly used in the manufacture of optical fiber, the porous mass that results from the deposition process is composed of fine GeO₂ and SiO₂ glass powders, or soot. It is believed that, although subsequent consolidation of the porous mass into a nonporous, transparent glass article allows some homogenization of the GeO₂ dopant concentration, the granular distribution of dopant reflecting the porous soot structure prior to consolidation is not substantially eliminated. The glass article may be a consolidated optical fiber core preform, a core cane drawn from a consolidated optical fiber core preform, or a complete optical fiber preform. It is further believed that final drawing of a complete optical fiber preform into optical fiber also has little impact on such nanometer-scale fluctuations in dopant concentration. Consequently, chemical inhomogeneity that can lead to increased optical attenuation is passed to the optical fiber.

Nanometer-scale chemical inhomogeneity contributes to optical fiber attenuation by producing similar-scaled fluctuations in the local refractive index of the optical fiber. For example, the refractive index of GeO₂—SiO₂ glass systems increases monotonically as the GeO₂ content of the glass increases. Variations in the GeO₂ content of only a few mole percent can change the refractive index by as much as 0.01. Fluctuations in the refractive index of the glass result in increased scattering, which, as previously discussed, has a direct impact on the fiber optical attenuation. It is theorized that the scattering component most affected by the refractive index fluctuations is Rayleigh scattering.

We have found that heat treating a consolidated glass article used in the production of optical fiber at a temperature and for a time sufficient to more uniformly diffuse Si ions, and ions of the one or more dopants used as index of refraction modifiers, from areas where their respective concentrations are high to areas where their respective concentrations are low, decreases refractive index fluctuations in the glass. Such a reduction in refractive index variation can result in improved attenuation performance for optical fiber utilizing core glass from a treated glass article when compared to the attenuation performance of a substantially identical optical fiber utilizing core glass from an untreated glass article.

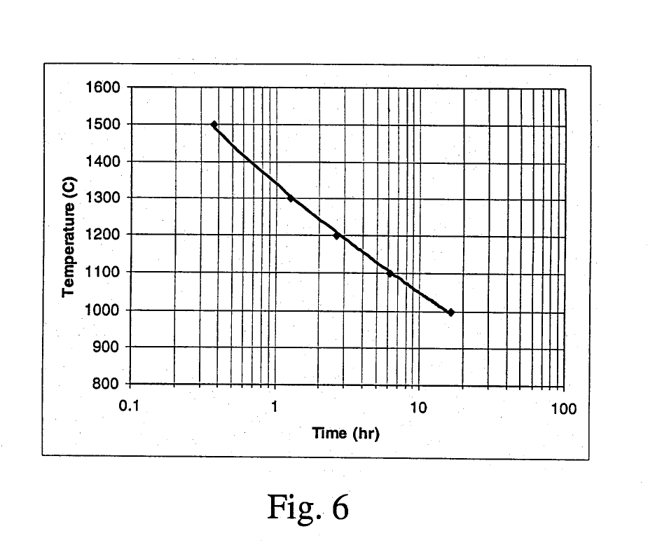

Of particular importance to the telecommunications industry are optical fibers drawn from SiO₂—GeO₂ glass. Although diffusion rates for Si and Ge ions in a SiO₂-GeO₂ glass are not well known, it is theorized that the diffusion rates for Si and Ge ions are similar to the diffusion rate for molecular oxygen in an SiO₂ glass, since all involve the breaking of metal-oxygen bonds. The diffusion of molecular oxygen in SiO₂ glass has been well studied, but the diffusion rates for molecular oxygen in an SiO₂—GeO₂ glass system are not well known. However, the diffusion rates of molecular oxygen in an SiO₂—GeO₂ glass can be estimated by using the inverse relationship between diffusion and viscosity. Thus, the diffusion of molecular oxygen in SiO₂—GeO₂ glass can be used as a conservative estimate of the diffusion of Si and Ge ions in SiO₂—GeO₂ glass. Given the lower viscosity of SiO₂—GeO₂ glass when compared to SiO₂ glass, we expect that diffusion rates for molecular oxygen, and therefore for Si and Ge, will be higher in SiO₂—GeO₂ glass than in SiO₂ glass. To estimate the root mean square diffusion distance for molecular oxygen in SiO₂—GeO₂ glass, we used the approximation d=sqrt(2*D*t), where d is the root mean square diffusion distance, D is the diffusion rate in m²/s (alternatively cm²/s) for a given temperature and t is the time in seconds. D can be calculated from the expression D=Dₒe^{(-A/RT)} where Dₒ is the constant 5.54×10¹¹, A is the activation energy in kiloJoules for molecular oxygen diffusion, R is the gas constant, and T is absolute temperature in Kelvin. Observations have shown the length scale of inhomogeneity in chemical vapor-deposited SiO₂—GeO₂ glass systems to be on the order of 10 nm, thus the average Si and Ge diffusion lengths for effective heat treatment according to the present invention are preferably greater than about 10 nm, more preferably greater than about 20 nm, and most preferably greater than about 30 nm. As an example, data points for a diffusion length of 30 nm were generated using the simple relationships given above, and are shown in FIG. 6. The data for this example can be approximated by a curve, also shown in FIG. 6, represented by the equation Tₑ=1339/t^{(0.1)}, where Tₑ is the temperature in degrees centigrade and t is the time in seconds. For the purposes of illustration, time t in FIG. 6 has been converted to hours. Heat treatment is bounded by a temperature of no greater than the softening point of the glass, typically about 1400° C. for fused silica. At temperatures in excess of the softening point of the glass, the glass article may begin to deform, which is undesirable. A lower boundary temperature is dependent upon the length of time that can be afforded to implement the heat treatment, as the time required for heat treatment increases as the heat treatment temperature decreases. Preferably, the lower boundary temperature is about 1100° C.

One example of a method for forming a glass article by chemical vapor deposition is illustrated in FIGS. 1-5. A circularly symmetric porous core preform may be formed in accordance with the method illustrated in FIG. 1. The ends of mandrel 10 are mounted in a lathe where the mandrel is rotated and translated as indicated by the arrows. Mandrel 10 may be provided with a layer of carbon soot to facilitate removal of the porous core preform from the mandrel.

Fuel gas and oxygen or air are supplied to burner 12 from a source (not shown). This mixture is burned to produce a flame 14 which is emitted from burner 12. A gas-vapor mixture is oxidized within the flame to form a soot stream 16 which is directed toward mandrel 10. Suitable means for delivering the gas-vapor mixture to the burner are well known in the art; for an illustration of such means reference is made to U.S. Pat. Nos. 3,826,560, 4,148,621 and 4,173,305. One or more auxiliary burners (not shown) may be employed to direct flame 14 toward one or both ends of the soot preform during deposition to prevent breakage of the preform. For an illustration of suitable auxiliary burners, reference is made to U.S. Pat. Nos. 3,565,345 and 4,165,223.

Burner 12 is generally operated under conditions that will provide acceptably high laydown rates and efficiency while minimizing the buildup of soot on the face thereof. Under such conditions, the flow rates of gases and reactants from the burner orifices and the sizes and locations of such orifices as well as the axial locations thereof are such that a well focused stream of soot flows from burner 12 toward mandrel 10. In addition, a cylindrical shield (not shown) which is spaced a short distance from the burner face, protects the soot stream from ambient air currents and improves laminar flow. Preform 18 is formed by traversing mandrel 10 many times with respect to burner 12 to cause a build-up of layers of silica-containing soot. The translating motion could also be achieved by moving burner 12 back and forth along the rotating mandrel 10 or by the combined motion of both burner 12 and mandrel 10. After deposition of soot preform 18, mandrel 10 is pulled therefrom, thereby leaving a longitudinal aperture through which drying gas may be flowed during consolidation.

The steps of drying and consolidating the optical fiber core preform may be performed in accordance with the teachings of U.S. Pat No. 4,165,223, which patent is hereby incorporated by reference.

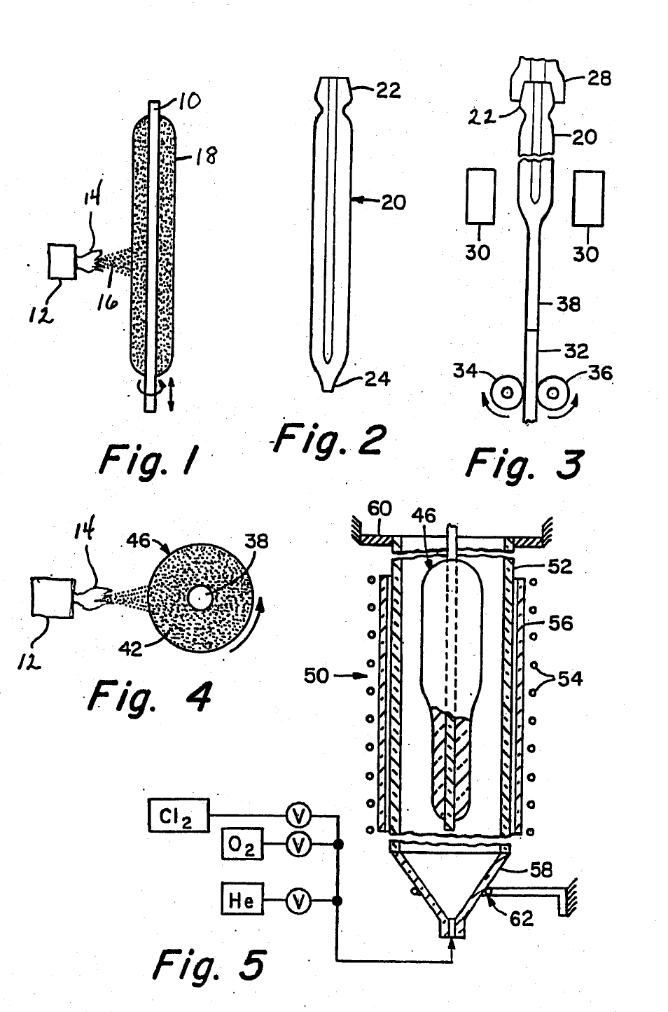

A consolidated optical fiber core preform 20 is illustrated in FIG. 2. During consolidation, core preform 20 may be suspended by a handle 22 which may be attached to core preform 20 during the deposition process or after the mandrel has been removed. Such handles have a passage therethrough for supplying drying gas to the preform aperture.

Drying can be facilitated by inserting a short section of capillary tubing into that end of the porous preform aperture opposite handle 22. The capillary tubing initially permits some of the drying gas to flush water from the central region of the core preform. As the porous preform is inserted into a consolidation furnace to dry and consolidate the preform, the capillary tubing aperture closes to form a solid plug, thereby causing all drying gas to thereafter flow through the preform interstices.

The consolidation atmosphere may contain helium and oxygen and an amount of chlorine. Chlorine gas is included to aid in water removal from the preform. In particular, chlorine permeates the interstices of the soot preform and flushes out any OH, H₂ or H₂O contained therein. The preform is then heated at a high temperature (generally in the range of between about 1450° C. to about 1600° C., depending upon preform composition) until the deposited soot consolidates and transforms into a solid, high-purity glass having superior optical properties. Once the preform is consolidated, it is removed from the furnace and transferred to an argon-filled holding vessel.

After consolidation, the consolidated optical fiber core preform aperture will be closed at end 24 as shown in FIG. 2 due to the presence of the aforementioned capillary plug. If no plug is employed the entire aperture will remain open. In this event end 24 is closed after consolidation by a technique such as heating and pinching the same.

Consolidated core preform 20 of FIG. 2, which will form a least a portion of the core of the resultant optical fiber, is etched to remove a thin surface layer. It is then stretched into at least one core cane, which is thereafter provided with additional core glass or with a cladding glass.

The core cane can be formed in a conventional draw furnace wherein the tip of the consolidated preform from which the core cane is drawn is heated to a temperature which is slightly lower than the temperature to which the preform would be subjected to draw optical fiber therefrom. A temperature of about 1900° C. is a suitable temperature. A suitable method for forming a core cane is illustrated in FIG. 3. Consolidated core preform 20 is mounted in a conventional draw furnace where the tip thereof is heated by resistance heater 30. A vacuum connection 28 is attached to handle 22, and the core preform 20 aperture is evacuated. A glass rod 32, which is attached to the bottom of core preform 20, is pulled by motor-driven tractors 34 and 36, thereby causing the core cane 38 to be drawn from core preform 20 at a suitable rate. A rate of 15 to 23 cm/min has been found to be adequate. As the core cane is drawn, the aperture readily closes since the pressure therein is low relative to ambient pressure. The diameter of the core cane that is to be employed as a mandrel upon which additional glass soot is to be deposited is preferably in the range of 4 to 10 mm.

Core cane 38 is mounted in a lathe where it is rotated and translated with respect to burner 12 shown in FIG. 4. A coating 42 of silica soot is thereby built up on the surface thereof to form a composite preform 46. Composite preform 46 is heated in consolidation furnace 50, shown in FIG. 5, to form a complete, consolidated optical fiber preform. Consolidation furnace 50 comprises a high silica content muffle 52 surrounded by heating elements 54. A high silica content liner 56 separates heating elements 54 from muffle 52. The term “high silica content” as used herein means pure fused silica or a high silica content glass such as a borosilicate glass. Consolidation gases are fed to the bottom of muffle 52 through a conical section 58 which is affixed thereto. Silica muffle 52 is supported at its upper end by a ring 60. Conical section 58 is supported by ringstand 62. The consolidation gases flow through one or more holes in conical section 58. The complete consolidated optical fiber preform is then further heated in a drawing furnace and drawn into optical fiber. Those skilled in the art will recognize that the OVD process described above is but one method of forming an optical fiber by chemical vapor deposition, and the present invention is not limited by this single example.

In one embodiment of the present invention, the consolidated glass article is a consolidated optical fiber core preform. The consolidated optical fiber core preform is formed by any one of the various chemical vapor deposition processes, including, but not limited to, OVD, VAD or MCVD. Preferably, the consolidated optical fiber core preform is formed by OVD. The core preform is doped with at least one refractive index-modifying dopant. Preferably, the core preform is doped with F. More preferably, the core preform is doped with GeO₂. The consolidated optical fiber core preform is heat treated at a predetermined temperature in the range from about 1100° C. to about 1400° C., preferably the consolidated optical fiber core preform is heat treated at a predetermined temperature greater than about 1200° C. but less than about 1400° C., and most preferably greater than about 1250° C. but less than about 1350° C. Preferably the predetermined temperature is maintained constant within +/−10° C. during the heat treatment. The consolidated optical fiber core preform is heat treated for a time in the range between about 1 hour and 12 hours, preferably for a time in the range between about 2 hours and 10 hours, and most preferably for a time in the range between about 3 hours and 7 hours. The consolidated core preform is heat treated in an atmosphere comprising helium. For example, a suitable atmosphere could comprise air. Preferably the partial pressure of helium in the heat treating atmosphere is at least about 0.5 atmospheres. More preferably the heat treating atmosphere contains 100% helium. Preferably the heat treating atmosphere is flowed at a rate of at least about 5 liters per minute. More preferably the heat treating atmosphere is flowed at a rate of at least about 10 liters per minute. Preferably, the consolidated optical fiber core preform contains only core glass. More preferably, the consolidated core preform comprises both core glass and at least a portion of the cladding glass. After heat treating, the consolidated core preform may preferably be heated in a draw furnace and drawn into at least one core cane. Preferably, the core cane is further formed into a complete consolidated optical fiber preform by depositing or forming additional glass on the core cane. For example, the core cane may be sleeved to form a complete optical fiber preform. In another example, the core cane serves as the starting rod for further soot deposition, after which the core cane and additional soot are consolidated to form a complete consolidated optical fiber preform. In still another example, a combination of sleeving, soot deposition and consolidation may be used to form a complete optical fiber preform. The complete consolidated optical fiber preform may be heated in a draw furnace and drawn into optical fiber.

In another embodiment of the invention, the consolidated glass article is a core cane. The core cane is formed by any one of the various chemical vapor deposition processes, including, but not limited to, OVD, VAD or MCVD. Preferably, the core cane is formed by OVD. Preferably the core cane is formed by drawing the core cane from a consolidated core preform. The core cane is doped with at least one refractive index-modifying dopant. Preferably, the core preform is doped with F. More preferably, the core preform is doped with GeO₂. The core cane is heat treated at a predetermined temperature in the range from about 1100° C. to about 1400° C., more preferably the core cane is heat treated at a predetermined temperature greater than about 1200° C. but less than about 1400° C., and most preferably at a predetermined temperature greater than about 1250° C. but less than about 1350° C. Preferably the predetermined temperature is maintained constant within +/−10° C. during the heat treatment. The core cane is heat treated for a time in the range between about 1 hour and 12 hours, preferably for a time in the range between about 2 hours and 10 hours, and more preferably for a time in the range between about 3 hours and 7 hours. The core cane is heat treated in an atmosphere comprising helium. For example, a suitable atmosphere could be air. Preferably, the partial pressure of helium in the heat treating atmosphere is at least 0.5 atmospheres. More preferably the heat treating atmosphere contains 100% helium. Preferably the heat treating atmosphere is flowed at a rate of at least about 5 liters per minute. More preferably the heat treating atmosphere is flowed at a rate of at least about 10 liters per minute. Preferably, the core cane contains only core glass. More preferably, the core cane comprises both core glass and at least a portion of the cladding glass. Preferably, the core cane is further formed into a complete consolidated optical fiber preform by depositing or forming additional glass on the core cane. For example, the core cane may be sleeved to form a complete optical fiber preform. In another example, the core cane serves as the starting rod for further soot deposition, after which the core cane and additional soot are consolidated to form a complete consolidated optical fiber preform. In still another example, a combination of sleeving, soot deposition and consolidation may be used to form a complete optical fiber preform. The complete consolidated optical fiber preform may be heated in a draw furnace and drawn into optical fiber.

In still another embodiment, a complete consolidated optical fiber preform is formed by any one of the various chemical vapor deposition processes, including, but not limited to, OVD, VAD or MCVD. Preferably, the complete consolidated optical fiber preform is formed by OVD. The complete consolidated optical fiber preform is doped with at least one refractive index-modifying dopant. Preferably, the complete consolidated optical fiber preform is doped with F. More preferably, the complete consolidated optical fiber preform is doped with GeO₂. Preferably, the complete consolidated optical fiber preform is formed by depositing or forming additional glass on a core cane. For example, additional glass may be applied to the core cane by inserting the core cane into at least one glass tube, heating the glass tube to collapse the tube onto the core cane (sleeving) to form a complete consolidated optical fiber preform. In another example, additional glass may be applied to the core cane by depositing glass soot on the core cane to form a porous glass soot layer on the core cane. The core cane and the porous glass soot layer are heated to consolidate the porous glass soot layer onto the core cane, thereby forming a complete consolidated optical fiber preform. In still another example, combinations of sleeving with at least one glass tube is combined with soot deposition and consolidation to form a complete optical fiber preform. Prior to drawing into an optical fiber, the complete optical fiber preform is heat treated in accordance with the present invention. The complete optical fiber preform is heat treated at a predetermined temperature greater than about 1100° C. but less than about 1400° C., preferably the complete optical fiber preform is heat treated at a predetermined temperature greater than about 1200° C. but less than about 1400° C., and more preferably at a predetermined temperature between about 1250° C. and 1350° C. Preferably the predetermined temperature is maintained constant within +/−10° C. during the heat treatment. The complete optical fiber preform is heat treated for a time in the range between about 1 hour and 12 hours, preferably for a time in the range between about 2 hours and 10 hours, and more preferably for a time in the range between about 3 hours and 7 hours. The complete optical fiber preform is heat treated in an atmosphere comprising helium. For example, a suitable atmosphere could comprise air. Preferably, the partial pressure of helium in the heat treating atmosphere is at least 0.5 atmospheres. More preferably the heat treating atmosphere contains 100% helium. Preferably the heat treating atmosphere is flowed at a rate of at least about 5 liters per minute. More preferably the heat treating atmosphere is flowed at a rate of at least about 10 liters per minute. After being heat treated, the complete optical fiber preform may be heated in a draw furnace and drawn into optical fiber.

### EXAMPLES

The invention will be further clarified by the following example.

### Example 1

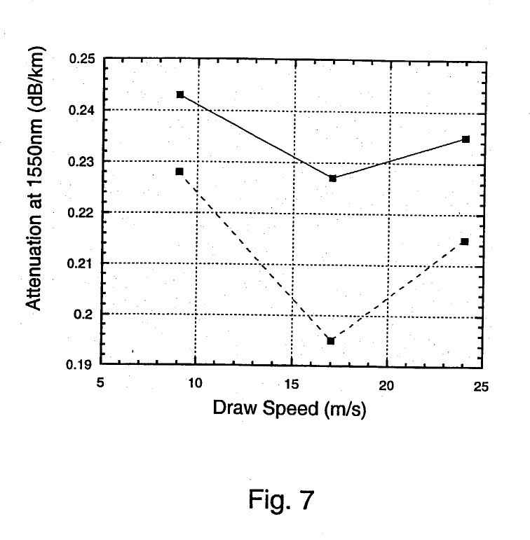

In one experiment, a porous optical fiber core preform was formed by outside vapor deposition and consolidated to form a nonporous consolidated optical fiber preform. The consolidated core preform contained GeO₂ as a dopant. The consolidated core preform was drawn to form a plurality of core canes. One core cane was then placed in a furnace and heat treated in accordance with the present invention at 1225° C. for 3 hours in a 100% helium atmosphere at atmospheric pressure. The helium was flowed at a rate of 10 liters per minute. A second core cane from the same core preform was not heated treated. Additional glass soot was deposited on both core canes by outside vapor deposition to form composite bodies. Both composite bodies were heated in a furnace to consolidate the porous soot layers onto the core canes to form complete optical fiber preforms. Each complete optical fiber preform was then drawn into optical fiber. Five draw conditions were used to manufacture the optical fiber from both complete optical fiber preforms. Each complete optical fiber preform was drawn at 9, 17 and 24 meters per second at a draw tension of 100 grams, 17 meters per second at a draw tension of 50 grams, and 17 meters per second at a draw tension of 150 grams. The resulting optical fibers were measured for optical attenuation at a wavelength of 1550 nm using both a Photon Kinetics 2500 attenuation measurement bench and an Optical Time Domain Reflectometer (OTDR). The attenuation measurement results are given in Table 1. The Photon Kinetics attenuation data for a draw tension of 100 grams is presented graphically in FIG. 7. In FIG. 7 the solid line represents attenuation for the fiber utilizing the untreated core cane, while the dashed line represents attenuation for the fiber utilizing the heat treated core cane. The optical fibers drawn from the complete optical fiber preform utilizing the heat treated core cane at draw speeds of 9, 17 and 24 meters per second and at a draw tension of 100 grams had optical attenuations that were reduced by approximately 0.02 dB/km when compared with the optical fiber drawn from the preform using the core cane that had not been heat treated. The remaining two draw conditions, 17 meters per second at both 50 and 150 grams tension, resulted in the optical attenuation of the fiber drawn from the complete optical fiber preform utilizing heat treated core cane having an optical attenuation that was reduced by approximately 0.002 dB/km at 1550 nm when compared with the optical fiber drawn from the preform using the core cane that had not been heat treated.

TABLE 1
Optical Attenuation (dB/km)

| | | Without | | With | | | |
|---|---|---|---|---|---|---|---|
| | | Heat Treatment | | Heat Treatment | | Difference | |
| | Speed | PK | OTDR | PK | OTDR | PK | OTDR |
| Tension | (m/s) | Attn. | Attn. | Attn. | Attn. | Atten. | Attn. |
| 150 g. | 17 | 0.214 | 0.2225 | 0.212 | 0.2205 | 0.002 | 0.0020 |
| 100 g. | 17 | 0.227 | 0.2320 | 0.195 | 0.2295 | 0.032 | 0.0025 |
| 50 g. | 17 | 0.219 | 0.2310 | 0.221 | 0.2275 | −0.002 | 0.0035 |
| 100 g. | 24 | 0.235 | 0.2400 | 0.215 | 0.2205 | 0.020 | 0.0195 |
| 100 g. | 9 | 0.243 | 0.2645 | 0.228 | 0.2410 | 0.015 | 0.0235 |

It is believed the difference in attenuation measurement results obtained for the 17 m/s draw speed at 50 g tension and at 150 g tension is attributable to the effect of draw tension.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A method of making an optical fiber comprising:
forming a consolidated glass article by a chemical vapor deposition process, said consolidated glass article being doped with at least one index of refraction-modifying dopant; and
heat treating said consolidated glass article at a predetermined temperature in the range from about 1100° C. to 1400° C. for a time between about 1 hour to 12 hours in an atmosphere comprising helium to form an optical fiber precursor.

2. The method of claim 1 wherein said atmosphere comprising helium in said heat treating step comprises air.

3. The method of claim 1 wherein said helium in said heat treating step is at a partial pressure of at least 0.5 atmospheres.

4. The method of claim 1 wherein said atmosphere comprising helium in said heat treating step is 100% helium.

5. The method of claim 1 wherein said predetermined temperature in said heat treating step is maintained constant within +/−10° C.

6. The method of claim 1 wherein said predetermined temperature in said heat treating step is in the range from about 1200° C. to 1400° C.

7. The method of claim 1 wherein said predetermined temperature in said heat treating step is in the range from about 1250° C. to 1350° C.

8. The method of claim 1 wherein said time in said heating step is between about 2 hours to 10 hours.

9. The method of claim 1 wherein said time in said heating step is between about 3 hours to 7 hours.

10. The method of claim 1 wherein said at least one index of refraction-modifying dopant in said forming step comprises GeO₂.

11. The method of claim 1 wherein said at least one index of refraction-modifying dopant in said forming step comprises F.

12. The method of claim 1 wherein said consolidated glass article in said heat treating step comprises a consolidated optical fiber core preform.

13. The method of claim 1 wherein said consolidated glass article in said heat treating step comprises a core cane.

14. The method of either of claim 12 or claim 13 wherein said consolidated glass article in said heat treating step comprises at least a portion of a cladding glass.

15. The method of claim 13 further comprising, prior to said heat treating step, depositing at least one layer of glass soot on said core cane, and consolidating said at least one layer of glass soot onto said core cane to form a complete optical fiber preform.

16. The method of claim 15 further comprising, prior to said depositing at least one layer of glass soot step, inserting said core cane into at least one glass tube, and heating said at least one glass tube to collapse said at least one glass tube onto said core cane.
